(19) United States
(12) Patent Application Publication
(10) Pub. No.: US 2004/0084915 A1
(43) Pub. Date: May 6, 2004

(54) Retainer for retaining collapsed poles within another pole

(75) Inventor: Wilbur Keith Moffatt, Freeport, IL (US)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(73) Assignee: GREENLEE TEXTRON INC., Rockford, IL

(21) Appl. No.: 10/694,134

(22) Filed: Oct. 27, 2003

Related U.S. Application Data
(62) Division of application No. 10/280,196, filed on Oct. 25, 2002.

(51) Int. Cl. B25J 1/00

(52) U.S. Cl. 294/19.1

(57) ABSTRACT

A tool is provided and includes a hook member which is attached to an extendable and retractable pole member, and a retainer which can retain the pole member in a collapsed position. The hook member is used to twist a short portion of a workpiece around a long portion of a workpiece in order to secure the short portion to the long portion when the workpiece is hung from an overhead support member. The retainer retains an inner pole of the pole member within an outer pole of the pole member when the pole member is in a collapsed position.

### CROSS-REFERENCE

This patent application is a divisional application of U.S. patent application Ser. No. 10/280,196, filed Oct. 25, 2002, and entitled “Wire Twisting Tool”.

### BACKGROUND OF THE INVENTION

The present invention relates to a tool for twisting a workpiece, such as wire, about itself to secure the workpiece to an overhead support member from which the workpiece is suspended. The tool can be operated by a user located a distance from the overhead support members, such that the user need not stand on a ladder or scaffolding to twist the workpiece, but may rather stand on the floor to accomplish same. The present invention also relates to a tool having a retainer for retaining collapsed poles within another pole. The retainer can be easily released to allow extension of the poles or locked to retain the poles in a collapsed position.

Tools used to perform the task of twisting a workpiece have existed for some time. One such tool is discussed in U.S. Pat. No. 4,694,869 and is entitled “Tool For Wrapping Drop Wires For Suspended Grid Ceiling”. This tool, however, is expensive to manufacture and can be difficult to use. Tools have also been used which allow a user to stand on the floor or ground to accomplish a task overhead without the use of a ladder or scaffolding. Many of these tools utilize extensible and retractable poles, such as those discussed in U.S. Pat. No. 4,385,849.

Problems with such extensible and retractable poles lie in the retaining of inner poles within the outer poles when the poles are collapsed within themselves. Such poles have the potential of the pole being extended unexpectedly by gravity while being carried, with such extension possibly resulting in a trip hazard or, at a minimum, a nuisance to the user.

One way in which this problem has been addressed is to provide a vinyl cap/hood or rubber stopper to address the problem. The cap/stopper approach, though, requires the hook/tool on the pole end, such as a twister hook of the present invention, to be removed before the cap/plug can be installed. If the cap/plug is separate, it can be easy to lose. Further, if the cap/plug is tethered to the poles, it can annoyingly be dangling in the line of sight of the user and/or can get caught on structure resulting in annoyance as well. Such caps/plugs can also be expensive to make as they are often molded. Caps/plugs can also be split, cut or torn in the field.

Therefore, a new tool used for twisting workpieces is desirable. A new tool for retaining poles which are collapsed within one another is also desirable. The present invention provides such a tool and the tool overcomes the disadvantages of the prior art. Features and advantages of the present invention will become apparent upon a reading of the attached specification, in combination with a study of the drawings.

### OBJECTS AND SUMMARY OF THE INVENTION

A primary object of the invention is to provide a tool having a hook member which can be attached to a pole member which is configured to allow a user to quickly and efficiently twist a first portion of a workpiece around a second portion of a workpiece to secure the portions of the workpiece together and to an overhead support member.

Another object of the invention is to provide a tool which can be rotated either clockwise or counter-clockwise to twist a first portion of a workpiece around a second portion of a workpiece to secure the portions of the workpiece together and to an overhead support member.

Another object of the invention is to provide a hook member which is inexpensive to manufacture which can twist a first portion of a workpiece around a second portion of a workpiece to secure the portions of the workpiece together and to an overhead support member.

Yet another object of the invention is to provide a tool which is easy for a user to use.

Yet another object of the invention is to provide a tool having a pole member which is retractable to allow for easy storage of the tool, and which is extensible to allow the tool to reach heights normally only reached by a user standing on a ladder, scaffolding or the like.

Still another object of the invention is to provide a retaining member for a pole member which is extensible and retractable which is compact and is out of the line of the user's line of sight when the pole member is extended.

Another object of the invention is to provide a retaining member for a pole member which is extensible and retractable which is relatively inexpensive to make and no tooling dollars are required.

Yet another object of the invention is to provide a retaining member for a pole member which is extensible and retractable which has no loose pieces which can get lost in the field.

Another object of the invention is to provide a retaining member for a pole member which is extensible and retractable which is durable such that it will not split, cut or tear.

Yet another object of the invention is to provide a retaining member for a pole member which is extensible and retractable which does not require the hook/tool on the end of the pole member to be removed for the retaining member to be used.

Briefly, and in accordance with the foregoing, the present invention provides a tool which includes a hook member which is attached to an extendable and retractable pole member, and a retainer which can retain the pole member in a collapsed position. The hook member is used to twist a first portion of a workpiece around a second portion of a workpiece in order to secure the first portion to the second portion when the workpiece is hung from an overhead support member. The retainer retains an inner pole of the pole member within an outer pole of the pole member when the pole member is in a collapsed position.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a hook member for a tool which incorporates features of the invention;

FIG. 2 is a side-elevational view of the hook member shown in FIG. 1;

FIG. 3 is a top plan view of the hook member shown in FIG. 1;

FIG. 4 is a bottom plan view of the hook member shown in FIG. 1;

FIG. 5 is a perspective view of the hook member shown in FIG. 1 connected to an extensible and retractable pole member which is formed in accordance with a first embodiment of the invention;

FIG. 6 is a cross-sectional side view of the pole member of FIG. 5 illustrating the pole member being collapsed within itself;

FIG. 7 is a cross-sectional side view of the pole member of FIG. 5 illustrating the pole member being extended;

FIG. 8 is a perspective view of the hook member connected to an extensible and retractable pole member which is formed in accordance with a second embodiment of the invention;

FIG. 9 is a cross-sectional side view of the pole member of FIG. 8 in a collapsed position and a retainer assembly retaining the pole member in a collapsed position;

FIG. 10 is a cross-sectional side view of the pole member of FIG. 8 in an extended position and the retainer assembly allowing the pole member to be in an extended position;

FIG. 11 is a side-elevational view of a pin member shown in FIGS. 8-10;

FIGS. 12-15 illustrate the method of using the hook member, with a pole member attached thereto, to twist a first portion of a workpiece around a second portion of a workpiece in order to secure the workpiece to an overhead support member; and

FIG. 16 is a cross-sectional side view of the pole member of FIG. 8 in an extended position and the retainer assembly allowing the pole member to be in an extended position, with a ring section of the retainer assembly being integrally formed with the pole member.

### DETAILED DESCRIPTION OF THE ILLUSTRATED EMBODIMENTS

While this invention may be susceptible to embodiment in different forms, there is shown in the drawings and will be described herein in detail, specific embodiments with the understanding that the present disclosure is to be considered an exemplification of the principles of the invention, and is not intended to limit the invention to that as illustrated and described herein.

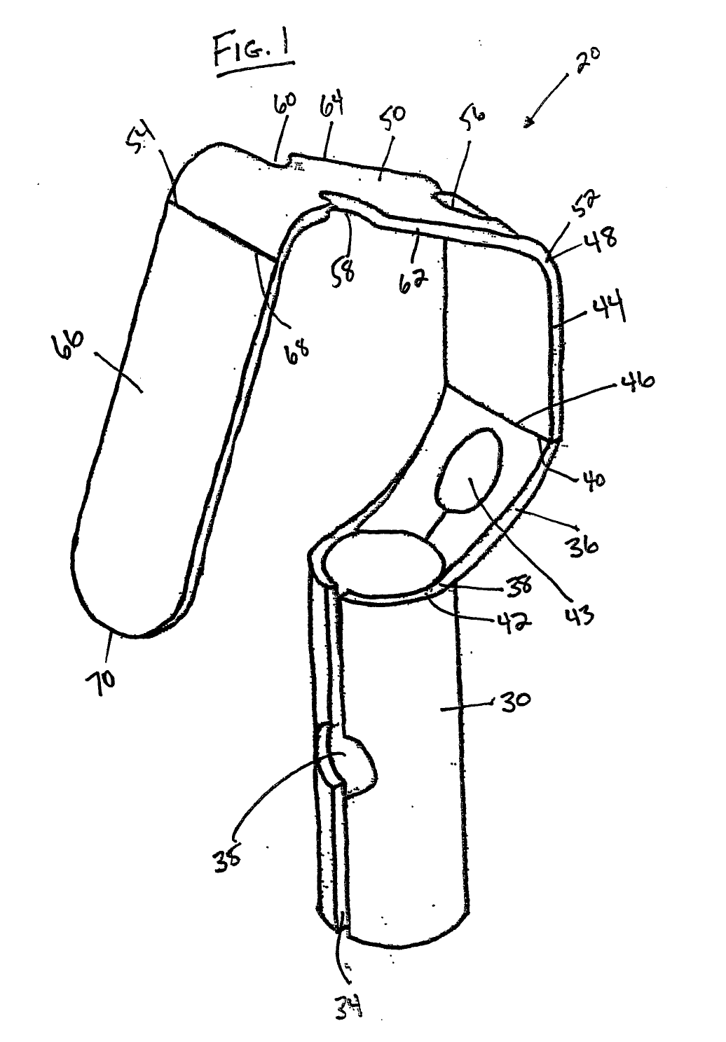

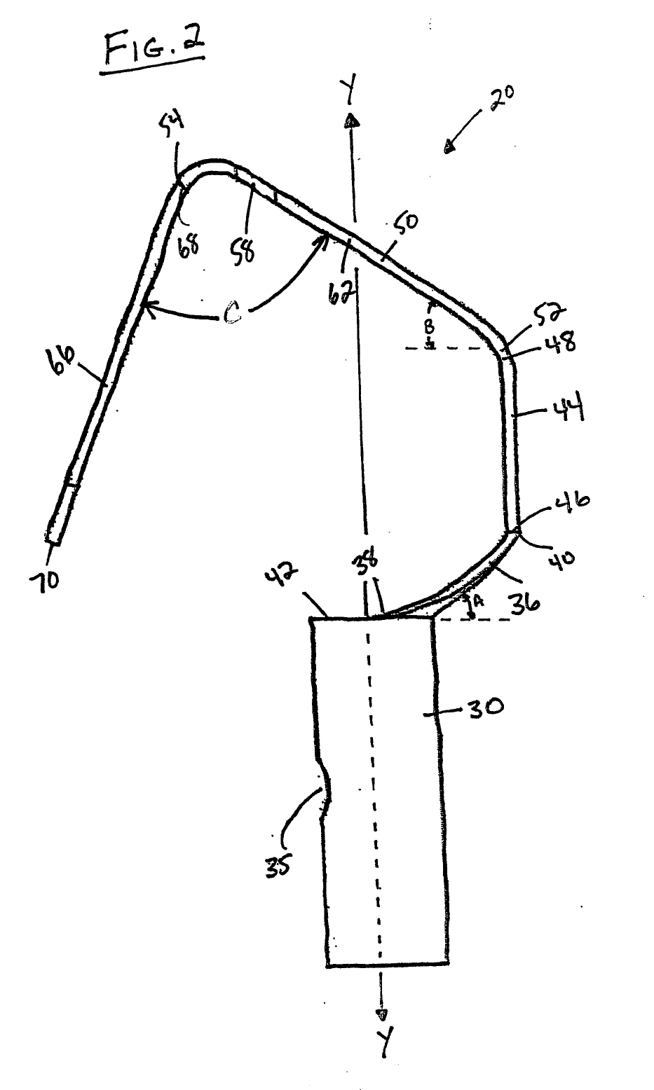

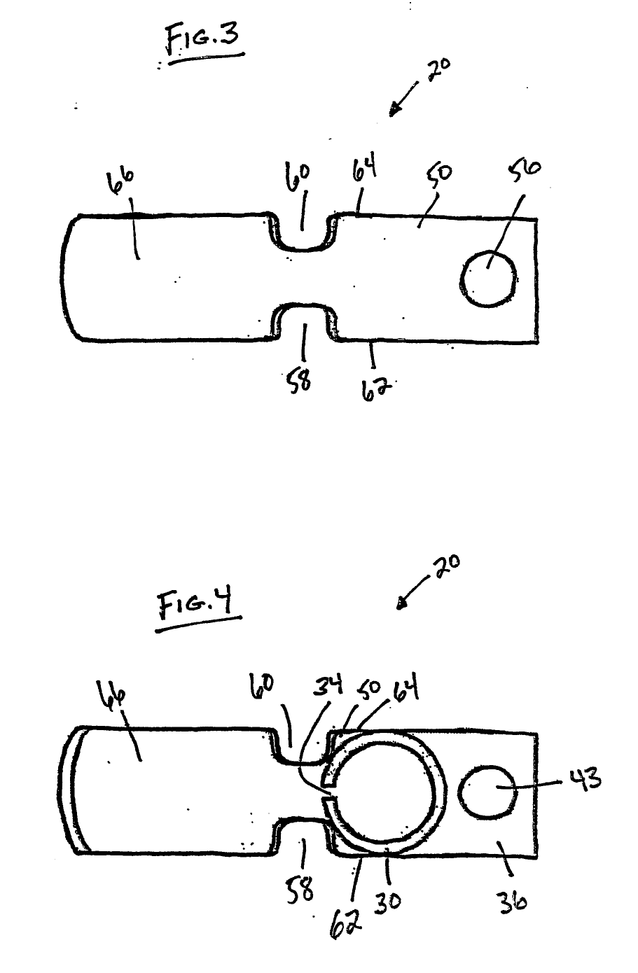

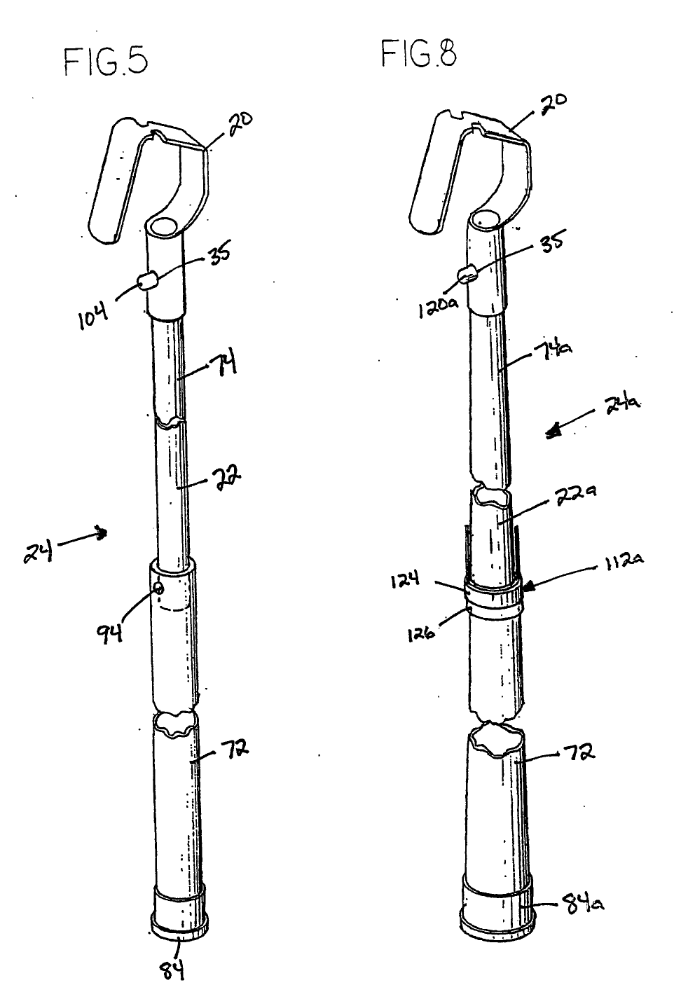

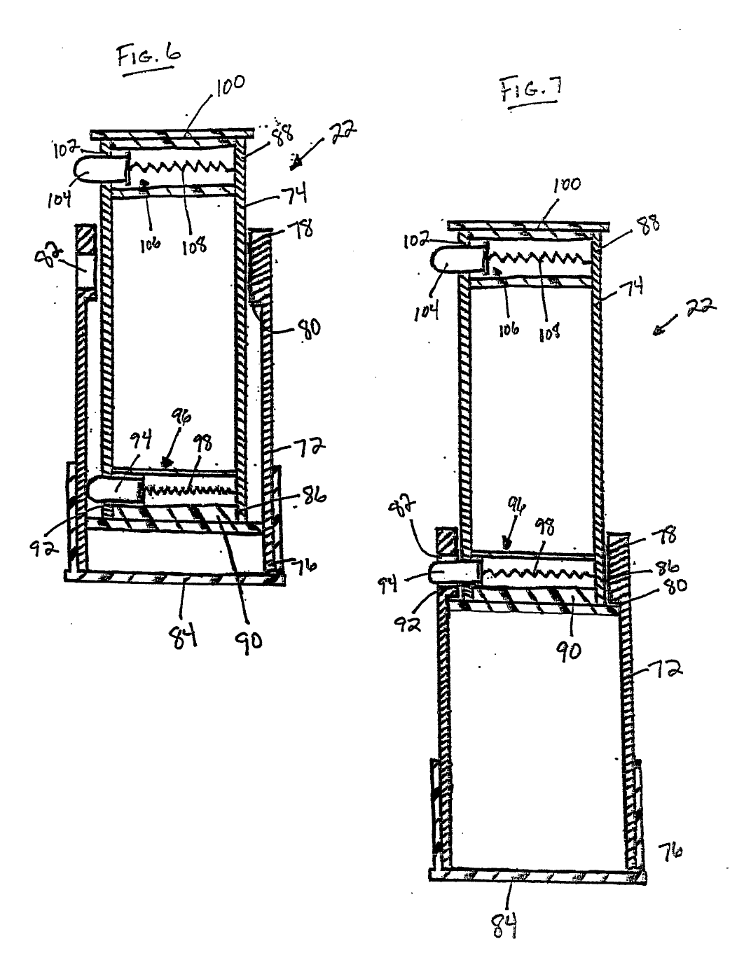

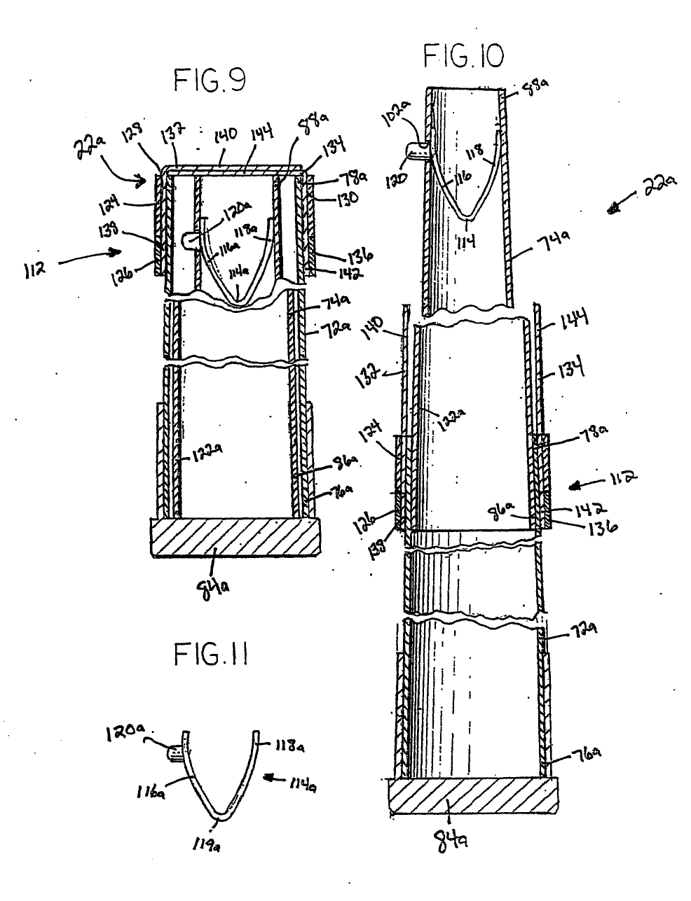

Attention is directed to FIGS. 1-4 which illustrate a hook member 20 for use on a tool 24, 24a. The hook member 20 is preferably attached to a pole member 22, 22a to provide the tool 24, 24a which is utilized for securing or twisting a workpiece 26, such as wire or rope, onto an overhead support member 28. The hook member 20 is preferably stamped from metal and thereafter bent to form such that it is relatively inexpensive to manufacture.

The hook member 20 has a first portion 30 which is preferably cylindrical such that the first portion 30 of the hook member 20 can be positioned around an end portion 32, 32a of the pole member 22, 22a. The first portion 30 has a centerline Y-Y which is aligned with the centerline of the tool 24, 24a. The first portion 30 may have a slot 34 which extends the length thereof to allow for the ability to position the hook member 20 on pole members 22, 22a of different diameters. The slot 34 also has an enlarged, generally circular portion 35 thereof which allows for a button 104, 104a of the pole member 22, 22a to be positioned therein, as will be discussed further herein.

The hook member 20 has a second portion 36 having first and second ends 38, 40. As illustrated in FIGS. 1 and 2, the first end 38 of the second portion 36 is connected to a portion of an end 42 of the first portion 30. From the first end 38 of the second portion 36, the second portion 36 extends upwardly and to the right of centerline Y-Y at an angle A from a line perpendicular to centerline Y-Y, when viewed as in FIG. 2, toward the second end 40 thereof such that the second end 40 of the second portion 36 of the hook member 20 is positioned further to the right of centerline Y-Y than the first portion 30 of the hook member 20 and the pole member 22, 22a. Angle A is preferably 30 degrees. The second portion 36 may extend either straight from the first end 38 to the second end 40, or may be slightly curved from the first end 38 to the second end 40. An aperture 43 is provided through the second portion 36 of the hook member 20 such that the aperture 43 is offset from the first portion 30 of the hook member 20 and the pole member 22, 22a.

The hook member 20 has a third portion 44 having first and second ends 46, 48. As illustrated in FIGS. 1 and 2, the first end 46 of the third portion 44 is connected to the second end 40 of the second portion 36. From the first end 46 of the third portion 44, the third portion 44 extends upwardly to the second end 48 thereof such that the third portion 44 is generally parallel to the first portion 32 of the hook member 20 and the pole member 22, 22a.

The hook member 20 has a fourth portion 50 having first and second ends 52, 54. As illustrated in FIGS. 1 and 2, the first end 52 of the fourth portion 50 is connected to the second end 48 of the third portion 44. From the first end 52 of the fourth portion 50, the fourth portion 50 extends angularly upwardly and to the left, beyond centerline Y-Y when viewed as in FIG. 2, at an angle B from a line perpendicular to centerline Y-Y toward the second end 54 thereof, which is positioned on the other side of the first portion 30 of the hook member 20 and the pole member 22, 22a than is the third portion 44, such that the second end 54 of the fourth portion 50 is positioned further to the left of centerline Y-Y than the first portion 30 of the hook member 20 and the pole member 22, 22a. Angle B is preferably 25 degrees. The fourth portion 50 extends generally straight from the first end 52 to the second end 54. An aperture 56 is provided through the fourth portion 50 of the hook member 20 such that the aperture 56 is offset from the first portion 30 of the hook member 20 and the pole member 22, 22a in the same direction in which the aperture 43 is offset from the first portion 30 of the hook member 20 and the pole member 22, 22a. The apertures 43, 56 are provided such that they are in alignment with one another and on an axis parallel to the centerline Y-Y.

The fourth portion 50 has a pair of notches 58, 60 provided along outer edges 62, 64 thereof, respectively. The notches 58, 60 are provided proximate to, but spaced from, the second end 54 of the fourth portion 50 such that notches 58, 60 are positioned further to the left of centerline Y-Y than the first portion 30 of the hook member 20 and the pole member 22, 22a.

The hook member 20 has a fifth portion 66 having first and second end 68, 70. As illustrated in FIGS. 1 and 2, the first end 68 of the fifth portion 66 is connected to the second end 54 of the fourth portion 50. From the first end 68 of the fifth portion 66, the fifth portion 66 extends angularly downwardly and to the left of centerline Y-Y when viewed as in FIG. 2, at an angle C relative to outer edge 62 to the second end 70 thereof, which is preferably rounded, such that the second end 70 of the fifth portion 66 is generally positioned further to the left of centerline Y-Y than is the second end 54 of the fourth portion 50. Angle A is preferably 75 degrees.

In a first embodiment of the tool 24, the hook member 20 is connected to the pole member 22, as illustrated in FIG. 5. In a second embodiment of the tool 24a, the hook member 20 is connected to the pole member 22a, as illustrated in FIG. 8. Each of the pole members 22, 22a are of the extensible and retractable type. Of course it should be noted that the pole member need not be of the extensible and retractable type.

Pole member 22 is illustrated in FIGS. 5-7 and includes an outer hollow tubular section 72 of substantially uniform outer diameter and an inner hollow tubular section 74 of substantially uniform outer diameter. Pole member 22 is known in the art and is discussed in detail in U.S. Pat. No. 4,385,849, entitled “Extensible And Retractable Rod”, which is incorporated herein by reference.

As best illustrated in FIGS. 6 and 7, the outer tubular section 72 has a first end 76 and a second end 78. An inner shoulder 80 is provided in the outer tubular section 72 proximate to the second end 78 thereof such that the outer tubular section 72 has a smaller inner diameter proximate to the second end 78 thereof than the inner diameter proximate to the first end 76 thereof. An aperture 82 is provided through the outer tubular section 72 between the inner shoulder 80 and the second end 78 thereof. A plug member 84 is provided at the first end 76 of the outer tubular member 72 to close the first end 76 of the outer tubular member 72. The second end 78 of the outer tubular section 72 is open to receive and retain the inner tubular section 74.

As best illustrated in FIGS. 6 and 7, the inner tubular section 74 has a first end 86 and a second end 88. The inner tubular section 74 has an outer diameter which is slightly smaller than the inner diameter of the outer tubular section 72 at the second end 78 thereof such that the inner tubular section 74 is slidable within the outer tubular section 72.

A plug member 90 is provided at the first end 86 of the inner tubular member 74 to close the first end 86 of the inner tubular member 74. The plug member 90 has an outer diameter which is slightly smaller than the inner diameter of the outer tubular section 72 proximate to the second end 76 thereof, but which is larger than the inner diameter of the outer tubular section 72 proximate to the second end thereof 78. An aperture 92 is provided through the inner tubular section 74 proximate to the first end 86 thereof which allows a button 94 of a button/spring assembly 96 housed in the plug 90 to extend therethrough. The spring 98 of the button/spring assembly 96 allows the button 94 to move laterally to the left and to the right when viewed as in FIGS. 6 and 7.

A plug member 100 is provided at the second end 88 of the inner tubular member 74 to close the second end 88 of the inner tubular member 74. An aperture 102 is provided through the inner tubular section 74 proximate to the second end 88 thereof which allows a button 104 of a button/spring assembly 106 housed in the plug 100 to extend therethrough. The spring 108 of the button/spring assembly 106 allows the button 104 to move laterally to the left and to the right when viewed as in FIGS. 6 and 7. The button 104 may extend through the enlarged, generally circular portion 35 of the first portion 30 of the hook member 20 to attach the hook member 20 to the pole member 22, as illustrated in FIG. 5. If the button 104 is pushed into the plug member 100, the hook member 20 may be removed from the pole member 22 as desired.

The inner tubular section 74 may travel within the outer tubular section 72 to extend or retract the pole member 22. To keep the pole member 22 in an expanded position, the button 94 of the button/spring assembly 96 is allowed to extend through the aperture 82 of the outer tubular section 72, such that the inner tubular section 74 is locked into place relative to the outer tubular section 72.

It should be noted that the pole member 22 could have more sections than just the outer and inner tubular sections 72, 74 discussed herein should it be desirable to extend the pole member 22 further than the combined length of the outer and inner tubular sections 72, 74 when the pole member 22 is in the expanded position.

The pole member 22a is illustrated in FIGS. 8-11 and includes an outer hollow tubular section 72a, an inner hollow tubular section 74a and a pole retaining assembly 112. Pole member 22a is known in the art and is discussed generally in U.S. Pat. Nos. 4,105,239, 3,993,013, 3,936,206, 3,936,088 and 3,865,498.

As best illustrated in FIGS. 9 and 10, the outer tubular section 72a has a first end 76a and a second end 78a. The outer tubular section 72a is generally tapered such that the outer tubular section 72a has a larger diameter proximate to the first end 76a thereof than proximate to the second end 78a thereof. A plug member 84a is provided at the first end 76a of the outer tubular member 72a to close the first end 76a of the outer tubular member 72a. The second end 78a of the outer tubular section 72a is open to receive and retain the inner tubular section 74a.

As best illustrated in FIGS. 9 and 10, the inner tubular section 74a has a first end 86a and a second end 88a. The inner tubular section 74a is generally tapered such that the inner tubular section 74a has a larger diameter proximate to the first end 86a thereof than proximate to the second end 88a thereof. An outer diameter of the inner tubular section 74a proximate to the first end 86a thereof is slightly larger than an inner diameter of the outer tubular section 72a proximate to the second end 78a thereof. The inner tubular section 74a is slidable within the outer tubular section 72a.

A retractable pin member 114a is provided at the second end 88a of the inner tubular member 74a. The retractable pin member 114a is preferably U-shaped such that it has a first leg 116a and a second leg 118a extending from a base 119a. The first leg 116a has a button 120a which extends outwardly away from the first and second legs 116a, 118a. The pin member 114a is preferably formed of spring steel such that the legs 116a, 118a can moved toward one another upon an application of force and, upon the removal of the force, spring back to its normal position. An aperture 102a is provided through the inner tubular section 74a proximate to the second end 88a thereof which allows the button 120a of the pin member 114a to extend therethrough. The legs 116a, 118a of the pin member 114a are positioned against the inner wall 122a of the inner tubular section 74a. The button 120a may extend through the enlarged, generally circular portion 35 of the first portion 30 of the hook member 20 to attach the hook member 20 to the pole member 22a, as illustrated in FIG. 8. If the button 120a is pushed to move the leg 116a toward the leg 118a within the inner tubular section 74a, the button 120a will be moved out of the enlarged, generally circular portion 35 of the first portion 30 of the hook member 20 such that the hook member 20 may be removed from the pole member 22a as desired.

It should be noted that the retractable pin member 114a could be utilized in connection with the pole member 22 as opposed to the plug 100 and the button/spring assembly 106 housed within the plug 100. Similarly, it should be noted that the plug 100 and the button/spring assembly 106 housed within the plug 100 could be utilized in connection with the pole member 22a as opposed to the retractable pin member 114a.

The inner tubular section 74a may travel within the outer tubular section 72a to extend or retract the pole member 22a. To keep the pole member 22a in an expanded position, the first end 86a of the inner tubular section 74a is moved toward the second end 78a of the outer tubular section 72a to provide a friction fit or slip joint between the inner and outer tubular sections 74a, 72a, as the outer diameter of the inner tubular section 74a proximate to the first end 86a thereof is slightly larger than the inner diameter of the outer tubular section 72a proximate to the second end 78a thereof.

It should be noted that the pole member 22a could have more sections than just the outer and inner tubular sections 72a, 74a discussed herein should it be desirable to extend the pole member 22a further than the combined length of the outer and inner tubular sections 72a, 74a when the pole member 22a is in the expanded position.

The pole retaining assembly 112 is best illustrated in FIGS. 8-10 and includes a ring section 124 and a hook and loop assembly 126. The pole retaining assembly 112 can be utilized in connection with either the pole member 22 of the first embodiment of the tool 24 or with the pole member 22a of the second embodiment of the tool 24a, or for that matter any other types of extensible and retractable pole members. For illustration purposes, though, the pole retaining assembly 112 is illustrated and described herein only in connection with the pole member 22a.

The ring section 124 of the pole retaining assembly 112 is positioned around the outer tubular section 72a of the pole member 22a at the second end 78a thereof. The ring section 124 is preferably attached to the outer tubular section 72a of the pole member 22a at the second end 78a thereof by appropriate means, such as by adhesive. The ring section 124 could also be integrally formed with the pole member 22a as illustrated in FIG. 16. The ring section 124 has a pair of slots 128, 130 provided therethrough which are positioned 180 degrees apart from one another. The ring section 124 is preferably formed of a fiberglass construction or of rubber.

The hook and loop assembly 126 includes first, second and third sections 132, 134, 136 which are at least partially formed of hook and loop fastener material commonly sold under the trademark VELCRO®. The first section 132 of the hook and loop assembly 126 extends through the slot 128 of the ring section 124 such that a first portion 138 thereof is positioned below the ring section 124 and such that an elongated second portion 140 thereof is positioned above the ring section 124, as shown in FIGS. 9 and 10. The second section 134 of the hook and loop assembly 126 extends through the slot 130 of the ring section 124 such that a first portion 142 thereof is positioned below the ring section 124 and such that an elongated second portion 144 thereof is positioned above the ring section 124, as shown in FIGS. 9 and 10. The third section 136 of the hook and loop assembly 126 extends around the outer tubular section 72a below the ring section 124, as shown in FIGS. 9 and 10, such that the third section 136 extends over the first portions 138, 142 of the first and second sections 132, 134, respectively, of the hook and loop assembly 126, thus attaching the third section 136 to the first and second sections 132, 134.

When the pole member 22a is collapsed within itself, such as in FIG. 9, the second portions 140, 144 of the first and second sections 132, 134, respectively, of the hook and loop assembly 126 can be folded one over the other to connect them together by fastening the loop portions of one of the portions 140, 144 with the hook portions of the other one of the portions 140, 144. When the collapsed pole member 22a is tipped down inadvertently, the inner tubular section 74a abuts against the connected second portions 140a, 144a of the first and second sections 132a, 134a of the pole retaining assembly 112a such that the second portions 140, 144 of the first and second sections 132, 134 prevent the inner tubular section 74a from sliding out of the outer tubular section 72a unexpectedly, thus retaining the inner tubular section 74a within the outer tubular section 72a. When the pole member 22a is to be extended, the second portions 140, 144 of the first and second sections 132, 134 can be separated by hand and retracted out of the way by moving the third section 136 down the outer tubular section 72a, away from the ring section 124, a short distance, for instance a few inches. The ring section 124 serves to guide and retain the hook and loop assembly 126 keeping it close to the outer tubular section 72a out of the line-of-sight of the user when working in limited spaces. In addition, the ring section 124 keeps the hook and loop assembly 126 from hanging up on structure as the pole member 22a is being used in small spaces.

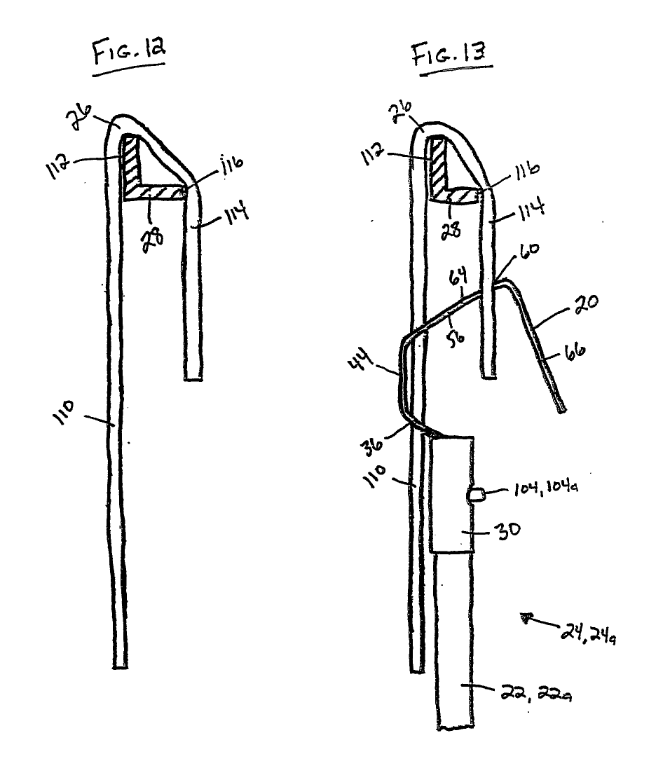

Operation of the tool 24, 24a will be discussed with relation to FIGS. 11-14. As best illustrated in FIG. 11, an overhead support member 28 is provided which has a workpiece 26, such as a wire, hanging thereover such that a first portion 110 of the workpiece 26 hangs from a first side 112 of the overhead support member 28 and a second portion 114 of the workpiece 26 hangs from a second side 116 of the overhead support member 28. One of the portions 110, 114 may be shorter than the other.

Once the workpiece 26 is positioned around the overhead support member 28 to provide both a first portion 110 and a second portion 114, a user uses the tool 24, 24a to twist the second portion 114 of the workpiece 26 around the first portion 110 of the workpiece 26 to secure the second portion 114 to the first portion 110, thus securing the workpiece 26 to the overhead support member 28.

The user moves the pole member 22, 22a to an extended position as illustrated in FIGS. 5 and 8. If the pole retaining assembly 112 is provided on the pole member 22, 22a, the user would first unfasten the second portions 140, 144 of the first and second sections 132, 134 of the hook and loop assembly 126. The user could then move the third section 136 of the hook and loop assembly 126 away from the open end 78a of the outer tubular section 72a in order to move the second portions 140, 144 of the first and second sections 132, 134 out of the line-of-sight of the user and to prevent same from getting hung-up on other structures.

The user moves the tool 24, 24a upwardly, generally from the ground or floor, toward the first portion 110 of the workpiece 26. The tool 24, 24a is then moved such that the first portion 110 of the workpiece 26 extends through the aperture 56 of the fourth portion 50 of the hook member 20, and is then moved such that the first portion 110 of the workpiece 26 extends through the aperture 43 of the second portion 36 of the hook member 20, such that the first portion 110 of the workpiece 26 is secured within the apertures 56, 43 of the hook member 20. The apertures 43, 56 are sized to accept the first portion 110 of the workpiece 26. The tool 24, 24a is then moved such that the second portion 114 of the workpiece 26 is positioned in one of the notches 58, 60 provided along the outer edges 62, 64 of the fourth portion 50 (FIG. 12 illustrates the second portion 114 of the workpiece 26 being positioned in notch 60 of outer edge 64), such that the second portion 114 of the workpiece 26 is secured by the notches 58, 60 of the hook member 20. The notches 58, 60 are sized to accept the second portion 114 of the workpiece 26.

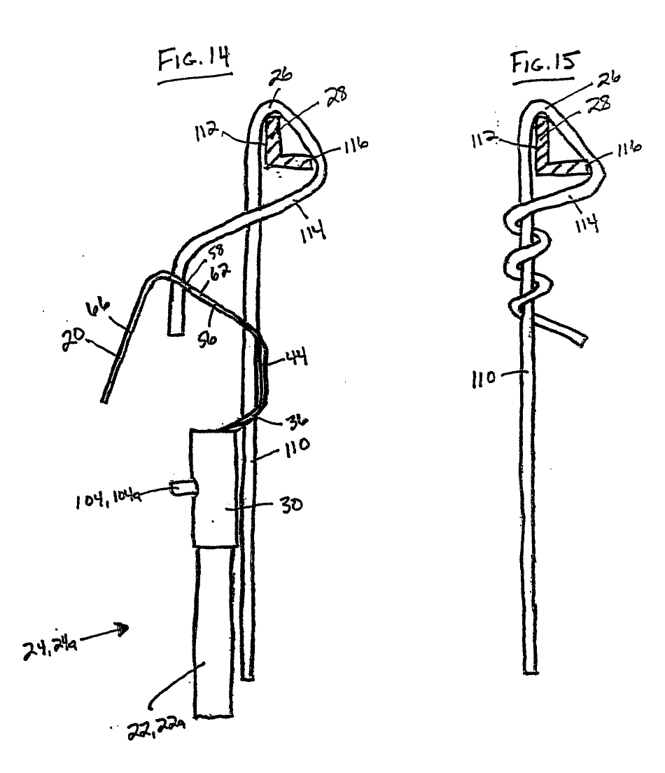

As illustrated in FIG. 13, the pole member 22, 22a is then rotated clockwise such that the first portion 110 of the workpiece 26 stays secure and rotates within the apertures 43, 56 of the hook member 20 while the fourth portion 50 of the hook member 20 abuts against the second portion 114 of the workpiece 26 to twist the second portion 114 around the first portion 110 of the workpiece 26, with the notch 60 keeping the second portion 114 in contact with the hook member 20, preventing it from slipping. Of course, it should be noted that if the second portion 114 of the workpiece 26 were secured in notch 58 along the outer edge 62 of the fourth portion 50, the pole member 22, 22a would be rotated counter-clockwise in order to twist the second portion 114 about the first portion 110.

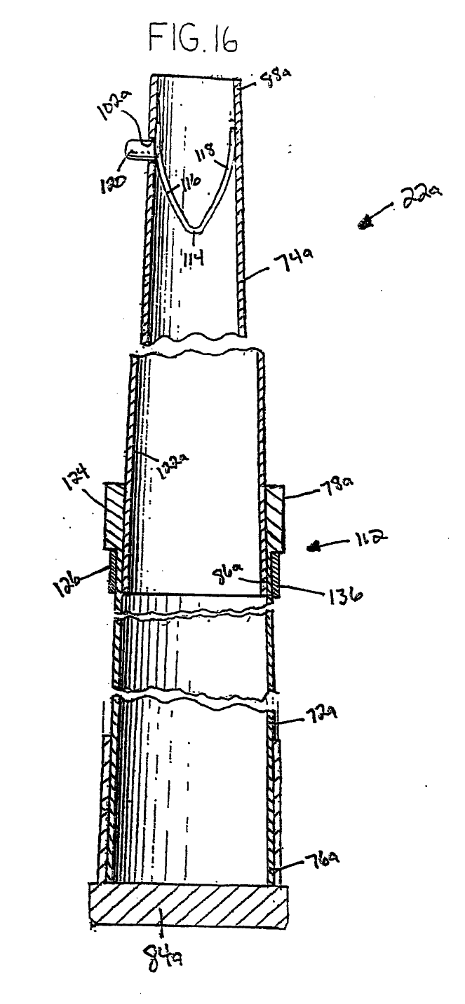

Continued rotation of the pole member 22, 22a continues the twisting of the second portion 114 around the first portion 110. The second portion 114 can be twisted around the first portion 110 as many times as desired. For example, as illustrated in FIG. 15, the second portion 114 can be twisted around the first portion 110 three (3) times.

Once the second portion 114 is twisted around the first portion 110 as many times as desired, the user then lowers the tool 24, 24a such that the first portion 110 of the workpiece 26 is removed from aperture 43 of the second portion 36 and then aperture 56 of the fourth portion 50, and such that the second portion 114 is no longer in contact with the notch 60 along the outer edge 64 of the fourth portion 50. As a result, the second portion 114 is twisted around the first portion 110 such that the workpiece 26 is secured to itself, as well as to the overhead support member 28.

It should be noted that the apertures 43, 56 through which the first portion 110 of the workpiece 26 is positioned, could instead be formed as notches provided along one of the outer edges of the second and fourth portions 36, 50, respectively, similar to the notches 58, 60 provided on the fourth portion 50. Rotation of the pole member 22, 22a, though, would only be allowed in one direction, depending on which of the outer edges of the second and fourth portions 36, 50 the notches were provided on.

It should also be noted that the notches 58, 60 which the second portion 114 of the workpiece 26 abut against could instead be formed as an aperture through the fourth portion 50, similar to the apertures 43, 56.

While preferred embodiments of the present invention are shown and described, it is envisioned that those skilled in the art may devise various modifications of the present invention without departing from the spirit and scope of the appended claims.

The invention is claimed as follows:

1. A retainer assembly for retaining at least one inner pole of an extensible and retractable pole assembly within an outer pole of the extensible and retractable pole assembly when the at least one inner pole is retracted within the outer pole, said retainer assembly comprising:
a first section having first and second portions,
a second section having first and second portions, said first portions of said first and second sections capable of fastening to one another across an open end of the outer pole to retain the at least one inner pole within the outer pole, and
a third section positioned around the outer pole which is fastened to said second portions of said first and second sections.

2. A retainer assembly as defined in claim 1, wherein said first, second and third sections are at least partially formed of hook and loop fastener material.

3. A retainer assembly as defined in claim 1, further including a ring section connected to and positioned around the open end of the outer pole, said ring section having a pair of slots provided therethrough which are opposite one another, said first section extending through one of said slots of said ring section such that said first and second portions of said first section are provided on opposite sides of said ring section, said second section extending through the other one of said slots of said ring section such that said first and second portions of said second section are provided on opposite sides of said ring section.

4. A retainer assembly as defined in claim 1, further including a ring section integrally formed with and positioned around the open end of the outer pole, said ring section having a pair of slots provided therethrough which are opposite one another, said first section extending through one of said slots of said ring section such that said first and second portions of said first section are provided on opposite sides of said ring section, said second section extending through the other one of said slots of said ring section such that said first and second portions of said second section are provided on opposite sides of said ring section.

5. A method of retaining at least one inner pole of an extensible and retractable pole assembly within an outer pole thereof when the at least one inner pole is initially in an extended position relative to the outer pole, said method comprising the steps of:
a) providing a retainer assembly including a first section having first and second portions, a second section having first and second portions, and a third section positioned around the outer pole which is fastened to said second portions of said first and second sections;
b) retracting the at least one inner pole within the outer pole to a collapsed position; and
c) fastening the first portions of said first and second sections of the assembly to one another across an open end of the outer pole such that the at least one inner pole is retained within the outer pole.
